(19) United States
(12) Patent Application Publication
(10) Pub. No.: US 2006/0085243 A1
(43) Pub. Date: Apr. 20, 2006

(54) Business process management method and system

(75) Inventors: Thomas A. Cooper, Sutton, MA (US); Jeffrey Curtis Kirk, Glenmoore, PA (US); Maciek Norbert Kolesnik, Burlington, MA (US); William F. Nazzaro, Collegeville, PA (US); Marc Lawrence Sacoolas, Scotts Valley, CA (US); Michael Joseph Waluk, West Kingston, RI (US)

Correspondence Address: WILMER CUTLER PICKERING HALE AND DORR LLP, 60 STATE STREET, BOSTON, MA, 02109, US

(73) Assignee: Workscape, Inc., Framingham, MA (US)

(21) Appl. No.: 10/949,883

(22) Filed: Sep. 24, 2004

(51) Int. Cl. G05B 19/418

(52) U.S. Cl. 705/8

(57) ABSTRACT

A service-oriented architecture includes applications, business services, business functions, and data repositories for developing human resource or other applications. A business service provides a set of business functions. The applications access business functions within business services. The business functions provide mechanisms for accessing and processing data in the data repositories. Applications may access business functions directly or through an interface that provides a common format for accessing the business functions. The business functions may access data through components that provide data transformation and mapping so that the business functions may be independent of the data format.

### TECHNICAL FIELD

This invention relates to service-oriented computer architectures and systems for business process management.

### BACKGROUND

In the human resources area of corporations, numerous situations exist in which employee information and data needs to be created, entered, accessed, or modified. For example, employees enroll in or change health plans, require changes to their family or other personal information, and become eligible for different programs. Administrators, managers, and employees need to create, enter, access, and review personnel data, compensation data, and other information.

The information may exist in different formats within numerous databases having different structures. Software programs for accessing the information may require different structures and formats. Different individuals may have differing rights to create, enter, view, or change the information, and different information may require different levels of confidentiality.

These conditions make it difficult to provide an effective system for providing different company personnel with the appropriate tools for creating, entering, accessing, and manipulating this information in an integrated manner.

### SUMMARY

A service-oriented architecture includes applications, business services, business functions, and data repositories for developing and deploying human resource or other applications. Applications correspond to a set of processes, and may include a graphical user interface. The applications access business functions within business services. The business functions provide mechanisms for accessing and processing data.

Applications may access business functions directly or through an interface that provides a common format for accessing the business functions. In some embodiments, the business functions access data through components that provide data transformation and mapping so that the business functions may be independent of the data format.

In some embodiments, the architecture uses open standards and common tools and protocols, such as Java and XML, and provides flexibility to develop, deploy, configure, and customize the applications, services, and functions. The applications may be web-based. The architecture allows the additions of functions without affecting applications.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system according to an embodiment of the present invention.

FIG. 2 is a second diagram of a system according to an embodiment of the present invention.

FIG. 3 is a block diagram of a business object document according to an embodiment of the present invention.

FIG. 4 is a diagram of a business object document according to an embodiment of the present invention.

FIG. 5 is a diagram of a business object document according to an embodiment of the present invention.

FIG. 6 is a diagram of a business object document according to an embodiment of the present invention.

FIG. 7 illustrates data flow between an application and a business service in accordance with an embodiment of the present invention.

FIG. 8 illustrates an exemplary set of business services, along with the business functions that each business service provides, according to an embodiment of the present invention.

FIG. 9 illustrates data flow between an external application and a business service in accordance with an embodiment of the present invention.

### DETAILED DESCRIPTION

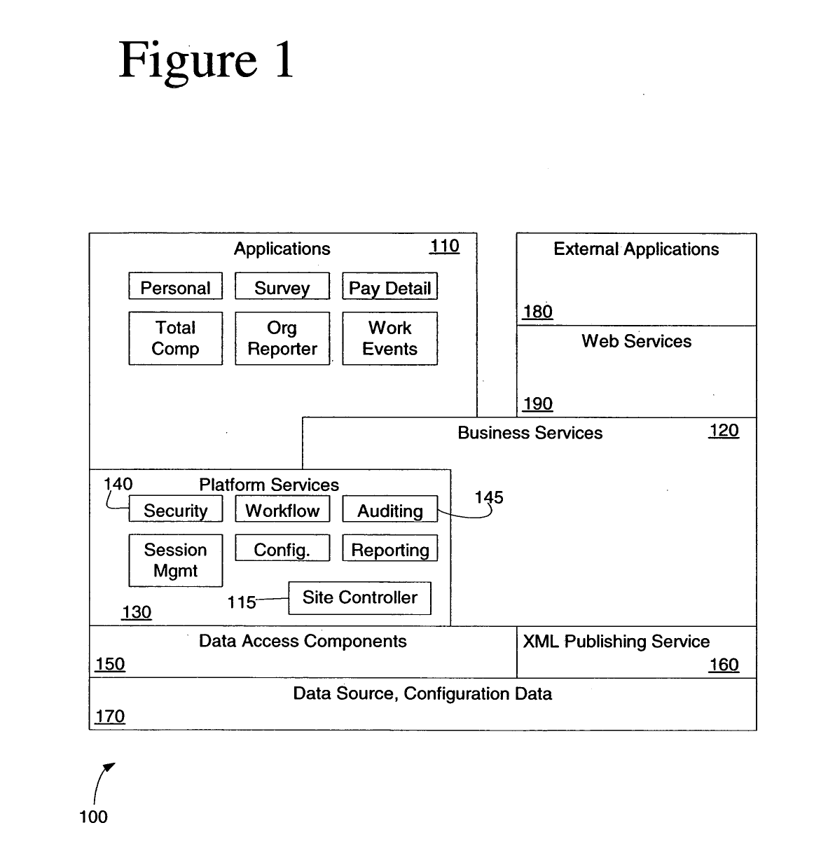

Referring to FIG. 1, an example of a human resources system with a services-oriented architecture in accordance with an aspect of the invention is depicted generally at 100. The system architecture includes a collection of components and defined interactions.

In some embodiments, internal applications 110 are web-based, written in Java, and built using Struts and Applet technology. Other technologies also may be used. Site controller 115 manages web flow. External applications 180 may be constructed with any computer language and architecture.

Applications include internal applications 110 and external applications 180. Internal applications 110 request processing from and interact directly with business services 120 and business functions (which are described below). In some embodiments, communication between internal applications 110 and business services and business functions occurs using data in an XML format.

External applications 180 may, for example, be legacy or other applications, which access the business services and business functions through a communication protocol and dispatch component, such as web services component 190. Internal applications 110, by contrast, access the business services and business functions directly. Web services component 190 checks requests from external applications 180 and formats those requests into the XML (or other appropriate format) required to access the business services and business functions. Going in the other direction, web services component 190 formats responses in a consistent XML format. Web services component 190 does not need to know the type of application receiving the data.

Business services 120 are collections of business functions, and may be organized to relate to the business domain rather than the database format in which the underlying data exists. The business services also, in some embodiments, provide housekeeping functions, such as configuration settings relevant to the service, or the collection of business functions provided by the service. Business functions provide the processing steps within a business service.

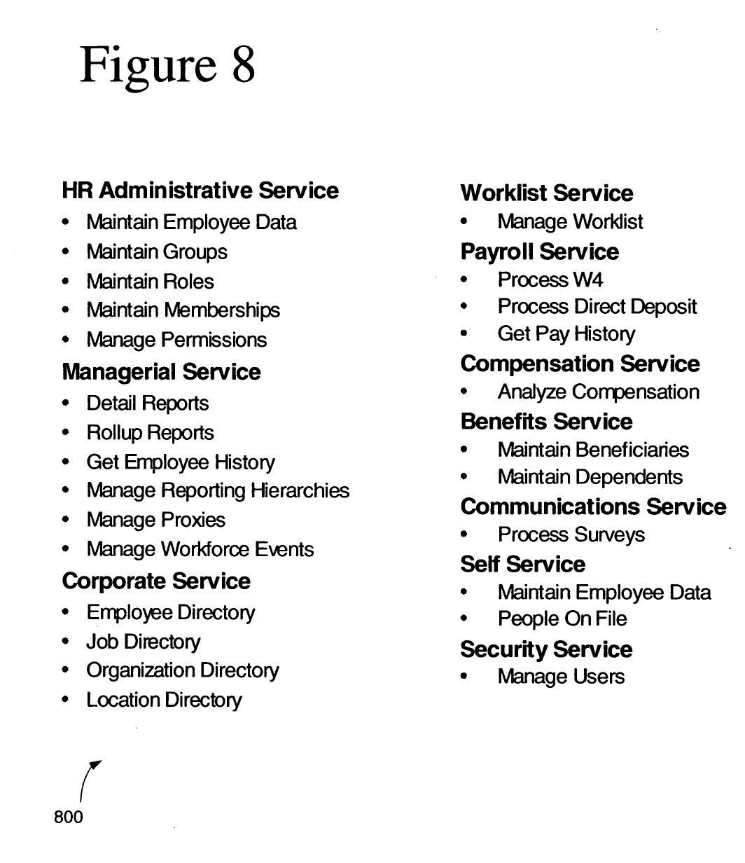

An exemplary catalog of business services and respective business functions is depicted generally at 800 in FIG. 8. In this Figure, an example of a business service is the “HR Administrative Service,” which enables the human resources administrative staff to interact with the overall system. Different business functions within “HR Administrative Service” are “Maintain Employee Data,” “Maintain Groups,” and “Maintain Roles.” Business functions include business logic and act upon data (such as XML data, in some embodiments). In some embodiments, each business function within a business service is distinct from the business functions in other business services. For example, the business function “Maintain Employee Data” in “HR Administrative Service” may not perform the same function as the “Maintain Employee Data” function within the “Self Service” business service. Alternatively, business functions in different business services can be substantially similar or even the same. Business functions perform activities on behalf of the caller, and according to instructions sent by the caller. In some embodiments, each function is independent and complete on its own, so the instructions sent by the caller has sufficient information to perform the function. A function may enlist other functions to perform its work, but the caller may not be aware of that.

In some embodiments, a business service includes a set of business functions common to many or all of the business services. For example, a “business function catalog” function lists business functions accessible through the selected service, filtered by permission and including the Business Object Document (BOD) schemas used to communicate information. The BOD for this function could be, for example, GetListBusinessFunction. Business services also may include, for example, business functions that are common only to one or a few business services.

In a human resources administrative service, functions available to authorized HR administrators may include, in some embodiments, a maintain employees function, to read and update data associated with an employee; a maintain groups function, to create and update group hierarchies; a maintain roles function, to create and update role hierarchies; a maintain memberships function, to assign memberships to roles and groups; and a manage permissions function, to manage permissions associated with role and group hierarchies. BODs associated with this last function, for example, can include: GetPermission, GetListPermission, CreatePermission, UpdatePermission, GrantGroupPermission, RevokeGroupPermission, GrantRolePermission, RevokeRolePermission.

In a managerial business service, functions may include, in some embodiments, a manage proxies function, to track authority delegated by a manager to act on his behalf for a period of time; a manage reporting hierarchies function, to review and make certain changes to reporting hierarchies; a detail reports function, to obtain detailed information for a manager's direct and indirect reports; a rollup reports function, to obtain rollup summary information for a manager's direct and indirect reports; a get employee history function, to access an employee's work history; and a manage workforce events function, to initiate and process workforce events requiring an approval process (including, for example, a job change, an organization transfer, a status change, separation, and a compensation change).

In a payroll business service for processing pay-related requests for employees, functions may include, in some embodiments, a process W4 function, to retrieve the current W4 form and process new and updated W4 forms; a process direct deposit function, to retrieve direct deposit information and update it; and a get pay history function, to retrieve pay records.

In a compensation service, functions may include, in some embodiments, an analyze compensation function, to calculate what-if scenarios based on compensation parameters, and to obtain summary compensation information; and a plan administration function, to create and administer plans, programs, elements and other compensation-related artifacts to support planning.

In a benefits service, functions may include, in some embodiments, a maintain beneficiaries function, to maintain the list of employee beneficiaries; and a maintain dependents function, to maintain the list of dependents and related benefit elections.

In a communications service for handling corporate communications to the workforce, functions may include, in some embodiments, a process surveys function, to manage surveys and associated survey responses. BODs involved in this function can include, for example, AddSurvey, UpdateSurvey, GetSurvey, GetListSurvey, CancelSurvey, GetCatalog, GetSurveyResponse, GetSurveyResponseData, and UpdateSurveyResponse.

In a corporate service for managing corporate-wide information typically readable by anyone (but where returned data can be filtered based on permissions of the caller), functions may include, in some embodiments, an employee directory function, to retrieve selected information about employees, filtered based on permissions; a job directory function, to retrieve selected information about jobs; an organization directory, to retrieve selected information about organizations; a location directory, to retrieve selected information about locations; and an employee groups directory, to create, query, and optionally persist employee groups based on visible attributes of accessible employees.

In a worklist service for individuals to access their list of work items, and other authorized persons to access work items across various subjects, functions may include, in some embodiments, a manage worklist function, to access work items for update or to recall.

In a self service business service, for employees to access information that the employee controls or information directed to the specific employee, functions may include, in some embodiments, a maintain employees function, to retrieve and change parts of an employee's own data that the employee is authorized to change; and a people on file function, to retrieve all individuals referenced in an employee's records, for example, contacts, dependents, and beneficiaries.

A security service may include, in some embodiments, a manage users function, to manage credentials and test login authorization. BODs related to this function may, for example, include UpdateUser, ProcessLogin, and CancelLogin.

In a budget business service, functions may include, in some embodiments, a budget administration function, to create budget numbers, splits, and rollups for use in compensation planning and other events requiring budgets; and a budget monitoring function, to analyze the effects of changing budget allocations and distributions.

In a reporting service, functions may include, in some embodiments, a report directory function, to access available reports; a report targeting function, to associate reports with events, processes, steps, or activities; and a report scheduling function, to schedule reports and maintain the queue.

In an integration business service for providing information transfer management, functions may include, in some embodiments, a subscription management function, to subscribe to information feeds based on events; an outbound queue management function, to manage the outbound Enterprise Resource Planning (ERP) queues; and an inbound queue management function, to manage input queues, frequencies, and policies from System of Record (SOR) and other data sources.

In a hierarchy service, functions may include, in some embodiments, an employee hierarchies function, to maintain a hierarchical grouping of employees; and a position hierarchies function, to control hierarchy of positions.

In a business process service for processing management functions for the system, functions may include, in some embodiments, a process definition, to define processes as steps, transitions, activities, events, and agents; and a process control function, to monitor and manage business processes.

In a performance management business service for providing task records and performance review functions, functions may include, in some embodiments, a goal management function, to manage goals and create links to other goals; and a performance ratings function, to create and maintain organizational and individual performance ratings.

Referring to FIG. 1, platform services 130 provide infrastructure and support functionality to the applications, services, and infrastructure itself. Platform services 130 provide a common programming environment for logging errors, audits, configurations, and other basic services. Examples of platform services 130 include security service 140 and auditing service 145. Platform services 130 are available directly to internal applications 110, business functions, and data access components, which are described below. In addition, in some embodiments, some or all platform services 130 may be accessed indirectly by external applications 180 through web services component 190.

In some embodiments, business services 120 encapsulate business logic using an extensible XML-based domain model. Business services 120 provide implementations of common business functionality to be shared among applications and made available through one or more communication protocol and dispatch components, of which the web services component is an example.

The business services access data through data access components 150. Data access components (“DACs”) form a data persistence framework that serves to insulate the business functions from the details of data transformation and mapping. They allow the system to perform, for example, create, read, update, and delete operations on the data. Persistence mapping and data store-specific details are encapsulated in the framework of data access components. Business functions use DACs to retrieve and persist objects in a data store. In some embodiments, DACs primarily represent access to a single domain object—a “noun” or “component”—and have XML schema-based interfaces. In some embodiments, DAC interfaces will not change when a new implementation is necessary for a change in the data store format. This insulates business services and functions from change and decouples the domain object schemas from a particular data store's details. DACs may be implemented by building XML documents from SQL/JDBC (Structured Query Language/Java DataBase Connectivity) result sets.

In order to perform their tasks, business functions in some embodiments interact with one or more DACs or other business functions, combining and/or dissecting their XML documents as necessary. The Data Access Component interfaces represent access to nouns and provide persistence to the databases. To use a different data source, a user may implement the DAC interfaces whose objects are persisted in the new back-end source.

Publishing service 160 allows business services 120 to be configured to publish (e.g., as XML) any changes to data that occur while using internal applications 110 or external applications 180. Publishing service 160 provides data but in some embodiments does not require confirmation of receipt by the receiving module. Publishing service 160 can function similarly to a business service, preserving the data in a BOD format and returning data to a queue. In some embodiments, publishing service 160 is able to push the data (e.g., to a queue) regardless of the noun, and to feed data in near real-time. In some embodiments, the publishing service is configured using a true/false logic state to publish (or not) all data traveling to a data repository.

The data itself are maintained in repository 170. In some embodiments, all or some of the data are provided within repository 170 in a format that allows them to be published to the applications without using publishing service 160. Repository 170 may also include configuration data.

At a lower level, the architecture includes the underlying operating system, an application server, and in some embodiments the Java Virtual Machine (JVM).

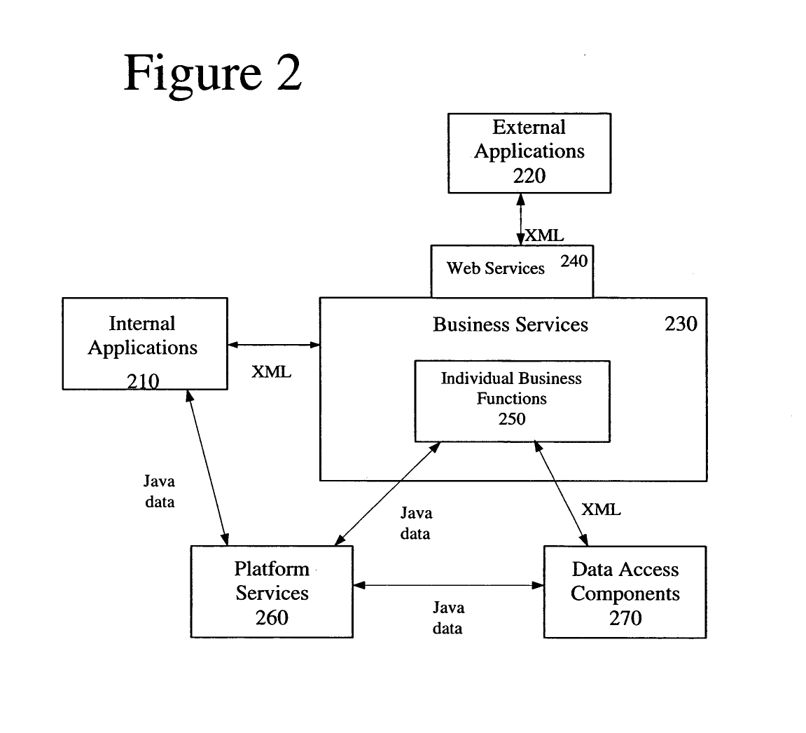

FIG. 2 illustrates an embodiment for communications among some of the components in an XML and Java implementation. External applications 220 communicate using XML with web services 240. Internal applications 210 communicate directly using XML with business services 230 and, through them, business functions 250. Internal applications interact with platform services 260 using Java. Platform services 260 use Java to communicate with business functions 250 and data access components 270. Business services 230 access data through data access components 270, using XML.

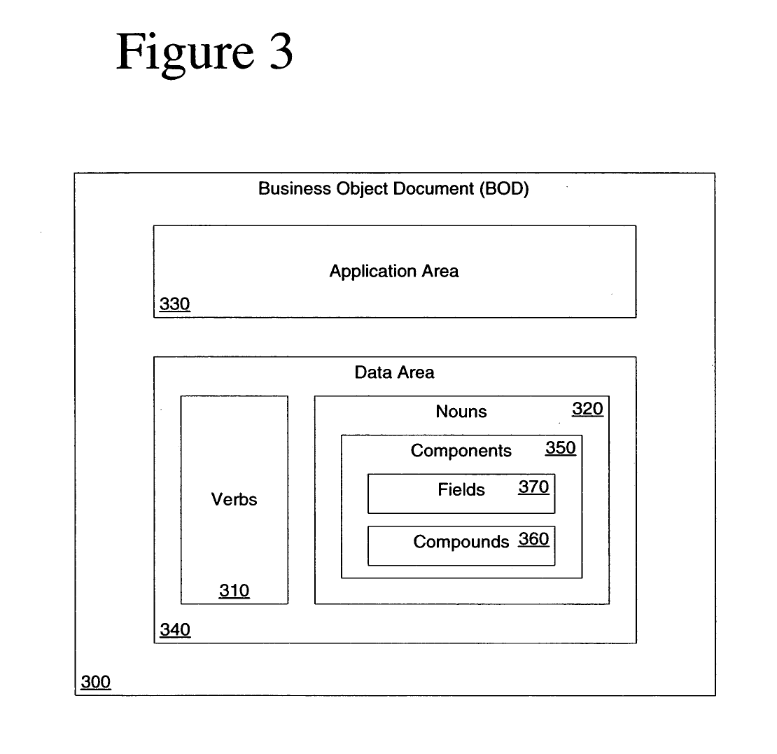

In some embodiments, applications and business services communicate using an XML Schema protocol that is based on Open Applications Group Integration Specification 8.0 (“OAGIS 8.0”) and HR-XML standards. Referring to FIG. 3, applications request a service by forming a specific business object document (BOD) 300 and sending it to a business service. The business service, likewise, responds by sending a BOD to the application. Each BOD has an associated XML Schema that defines the content of the BOD. In addition, some functions have an Extensible Style Language (XSL) transform that can enforce constraints beyond the capabilities of the schema. Both schema and transform constraints are applied when a business function receives a BOD.

Business object document 300 includes an application area 330 for identifying the sender and a data area 340 that defines the business operation. Application area 330 contains information that is used to communicate the message, e.g., information that identifies the sender, a time stamp, and unique document identification. The sender information can identify the sender by full credentials or by identity token, and may include proxy information. With both requests and responses, data area 340 carries the business specific payload or data being communicated by the BOD. Data area 340 includes a verb 310, which can be an XML fragment, that represents the action requested, and one or more nouns 320, which are the business object or objects (or other structures) to act upon. In some embodiments, the verbs that BOD 300 may use are a subset of those verbs defined in OAGIS, plus some verbs—such as “Approve,” “Reject,” and “Recall” in a human resource domain—that are specific to the domain.

Nouns carry information that is acted on by the verb in a BOD. In cases where a complex process is being initiated, the noun may represent information to start the process, and the verb may be “Process”. In some cases, the noun relates directly to a business document that is a familiar part of the domain, in which case the verbs that apply are ones that deal directly with document exchange (e.g., Create, Add, Cancel, etc.). Some nouns designate a business entity that is to be manipulated, such as Employee, Group, and Role, and are used with verbs that maintain that entity (Create, Get, Update, Delete). Nouns also can describe, for example, business process specific data, such as WorkforceEvent, Requisition, or PurchaseOrder; or associations, such as Membership, ProxyAssignment, or Permission. BODs can contain more than one noun, which in some embodiments must be of the same type (e.g., a request BOD may have two nouns that represent a requested range or multiple nouns in a batch-type request). Nouns can be added with each new application or business service as it is developed. In some embodiments, nouns include, for example:

| Noun | Description |
|---|---|
| Beneficiaries | Details of the set of beneficiaries for |
| | an employee. |
| BonusHistory | Sequence of bonus history events for an |
| | employee. |
| BusinessFunction | Details about a business function, |
| | including the associated BOD schema. |
| CollateralMaterial | Links and human-readable content that |
| | pertains to a service. For example, related |
| | government regulations and standards. |
| CompensationDetail | Details of compensation information of |
| | direct and indirect reports. |
| CompensationRollup | Rollup of a group's compensation |
| | information. |
| CompensationStatement | Total Compensation Statement |
| Dependents | Details about an employee's dependents. |
| DirectDeposit | Specifics about an employee's direct |
| | deposit enrollment. |
| Employee | Basic detail about the employee. (Profile). |
| EmployeeCompensation | Describes an employee's entire |
| | compensation package. |
| EmploymentHistory | Sequence of change of employment events for |
| | an employee. |
| Group | A named group with Employee members, and |
| | with associated Permissions. |
| GroupPermission | An association of a Permission with a Group. |
| HeadcountDetail | Selected details of the direct and indirect |
| | reports under a manager. |
| HeadcountRollup | Summary information about the headcount of |
| | a manager and direct and indirect reports. |
| Job | Identification of a job or position held by |
| | an employee. |
| JobHistory | Sequence of job history events for an |
| | employee. |
| Login | Information required to log into the system, |
| | returning an identity token. |
| Membership | A designation that an employee is a member |
| | of a particular group or role. |
| OrganizationalUnit | Basic information about an organization. |
| PayStub | Information about a past pay transaction. |
| PeopleOnFile | People referenced in an employee's file. |
| | May be used, for example, when making new |
| | references. |
| PerformanceDetail | Selected details on the performance of |
| | employees under a given manager. |
| PerformanceRollup | Summary information about the performance |
| | ratings of a manager's direct and |
| | indirect reports. |
| Permission | Grants access to certain functions or data |
| | to the employee holding the permission. |
| ProxyAssignment | Allows a user to be a proxy for an employee. |
| PurchaseOrder | Information about a purchase order. |
| ReportingHierarchy | A description of some portion of a reporting |
| | structure. |
| Requisition | Information about a requisition request. |
| RetirementProjections | Total Compensation Retirement Projections |
| Role | A Role that may be assigned to an Employee. |
| | Roles may have associated permissions, and |
| | may be hierarchical, with permissions |
| | inherited from higher-level roles. |
| RolePermission | An association of a Permission with a Role. |
| RuleCatalog | Machine-readable business rule settings (as |
| | configuration data) relevant to functions |
| | available in a particular service. |
| Survey | A set of questions that form a user survey, |
| | typically associated with an application. |
| SurveyResponse | A particular user's answers to a survey. |
| User | A user account for this system. |
| W4 | Federal tax withholding details. |
| WorkforceEvent | A set of specific workforce transactions |
| | that are to be approved and then enacted |
| | together. |
| WorkItem | A description of a piece of work for a |
| | user. Workforce Events are delivered via |
| | Work Items. |
| Worksite | Basic information about a worksite. |

The general description of each verb is made concrete when applied to a specific noun. Verbs used with the above nouns include:

| Request Verb | Response Verb | Description |
|---|---|---|
| Add | Acknowledge | A request to add an entity to |
| | | the service. |
| | | The caller makes a request to |
| | | create an entity, and take |
| | | action on it. |
| Approve | Acknowledge | Marks the associated item for |
| | | approval. |
| | | This may be used, for example, |
| | | for workforce events. |
| Cancel | Acknowledge | A request to “cancel” a |
| | | document. |
| | | This removes the associated |
| | | entity from consideration or |
| | | further processing. |
| Create | Acknowledge | Initiates the construction of |
| | | an entity within the service. |
| | | The connotation is that no |
| | | other action is triggered, |
| | | but more work will soon follow. |
| Get | Show | A request for an existing piece |
| | | of information. Results come in |
| | | a Show document. |
| | | Provides identification |
| | | criteria and a specification of |
| | | the parts of the noun to return. |
| GetList | List | A request for information about |
| | | one or more entities. Results |
| | | come in a List document. |
| | | Provides selection criteria to |
| | | be matched. Returns a List |
| | | document containing the |
| | | matching entities. May return |
| | | summarized information. |
| Grant | Acknowledge | Associates a right with an |
| | | employee. |
| | | Used to give permissions, roles, |
| | | and proxy authority to |
| | | employees. |
| Lookup | Show | A request for an existing piece |
| | | of information. Results come in |
| | | a Show document. |
| | | Provides additional criteria |
| | | over a Get verb that is not |
| | | necessarily part of the |
| | | matching nouns. |
| LookupList | List | A Lookup request for one or |
| | | more entities. Results come in |
| | | a List document. |
| | | Provides additional criteria |
| | | over a Get verb that is not |
| | | necessarily part of the |
| | | matching nouns. |
| | | Can specify the sort criteria |
| | | used by the resulting List |
| | | response. |
| Process | Acknowledge | Request the processing of the |
| | | entity by the business service. |
| | | The specific action to take is |
| | | embodied in the noun. |
| Recall | Acknowledge | Stop processing the related |
| | | item. |
| | | Usually requested by the |
| | | initiator, who no longer wishes |
| | | the action to take place. |
| Reject | Acknowledge | Rejects the associated item. |
| | | This may be used, for example, |
| | | for workforce events. |
| Revoke | Acknowledge | Revokes a right that an |
| | | employee has. |
| | | For example, permissions, roles, |
| | | and proxy authority. |
| Update | Acknowledge | Maintenance of a business |
| | | entity. |
| | | Contains instructions on making |
| | | one or more changes to an |
| | | entity. |

Nouns 320 include components 350. Components 350 are extensible building blocks for nouns, and are themselves comprised of compounds 360 and fields 370. For example, “Address” may be a component.

Compounds 360 are the basic, shared building blocks that are used by BODs (e.g., quantity or amounts), and are extensible through contextual use. Fields 370 are the lowest level element defined in OAGIS. Fields are used to create compounds and components (e.g., “Description” or “Name”).

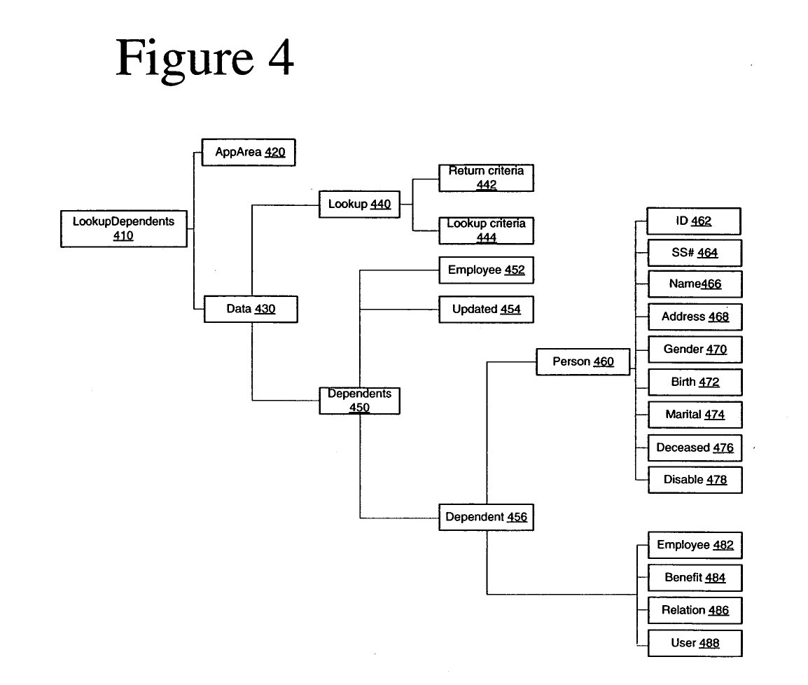

An example of a business object document is shown in FIG. 4. Request BOD 410, “LookupDependents,” may be used to request dependents information for a particular employee. As shown, BOD 410 includes application area 420 and data area 430. Data area 430 includes verb 440, in this example indicating the action is “lookup,” and noun 450, indicating the target business objects are “dependents.”

Verb 440 communicates to a business software component a request for an existing piece of information to be returned. The “Lookup” verb can be paired with most nouns. The response to a “Lookup” request is the “Show” verb. The behavior of a BOD with a Lookup verb is predictable across most of the nouns with which it can be paired. “Lookup” is designed to retrieve a single piece of information by using that information's primary retrieval field, i.e., the key field, which for verb 440 is “Dependents.” The Lookup verb is not used to request several documents at once. The LookupList verb is used to return as many matches as are designated. Verb 440 includes return criteria 442 and lookup criteria 444. Return criteria 442 allows the initiator of the BOD to indicate the information, down to the field level, that is requested to be returned. Lookup criteria 444 is an element containing the BOD-specific lookup criteria that is not captured in “Lookup” and “LookupList” requests. For example, Lookup criteria 444 has additional, noun specific criteria used to identify the specific result desired.

Noun 450 includes components employee 452, last updated 454, and dependent 456. Components 452 and 456 are also nouns. Component 454 (last updated) is a field indicating when the information was last updated. Dependent component 456 includes entity 460, containing person data, as well as employee component 482, benefit component 484, relationship component 486, and user area component 488. Entity 460 includes ID field 462, social security number field 464, name component 466, address component 468, sex field 470, birth date field 472, marital status field 474, deceased date 476, and “is disabled” field 478. As this example illustrates, fields can include numerical information, textual information, a date, Boolean data (such as “is disabled” field 478), or other information.

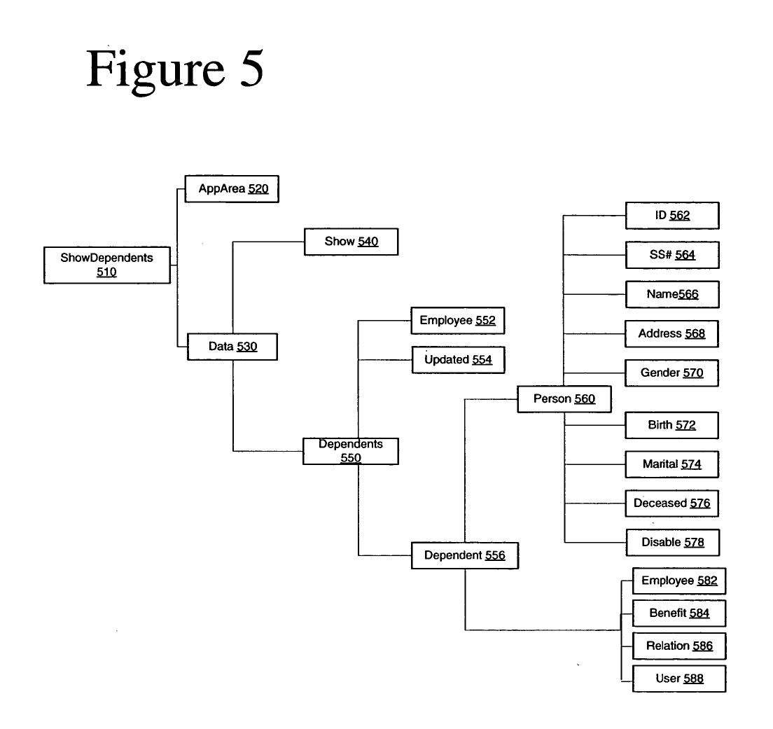

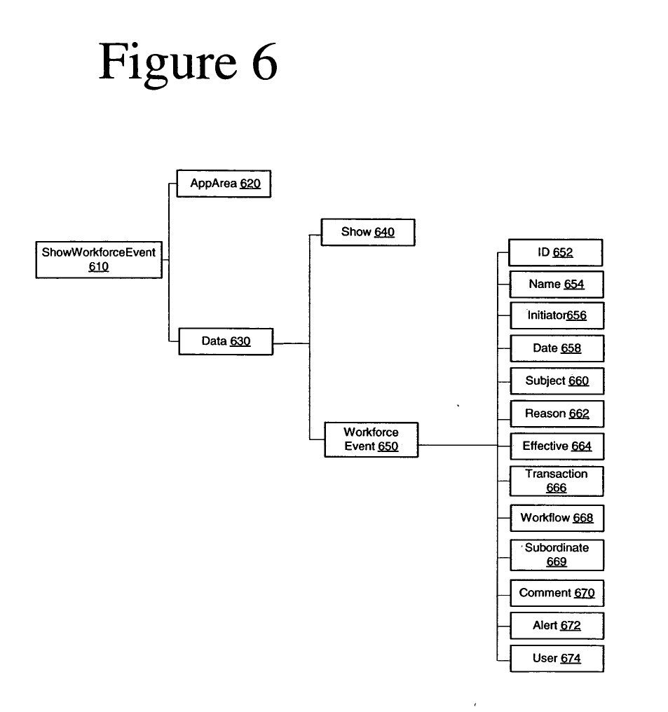

Two examples of response business object documents are shown in FIGS. 5 and 6. Response BOD 510, “ShowDependents,” is used to respond to a LookupDependents request BOD. BOD 510 includes application area 520 and data area 530. Application area 520 provides information that an application may use in order to communicate in an integration of two or more business applications. Application area 520 can include the characteristics and control identifiers that relate to the application that created the BOD, the logical location of the application and database server, a date and time stamp for the creation of the BOD, a signature element, a Globally Unique Identifier (“GUID”) that makes each BOD uniquely identifiable. This is useful, for example, in order to provide capabilities for legally-binding transactions, transaction logging, exception handling, re-sending, reporting, confirmations, and security. Application area 520 can also include a user area to extend the specification in order to provide additional information not captured in OAGIS. Data area 530, which contains the information requested by a Lookup request, includes “Show” verb 540 and “Dependents” noun 550. The “Dependents” noun 550 has the same structure as dependents noun 450 from FIG. 4. The “Show” verb is used when sending information about a specific instance of a business document or entity. It can also be used to respond to a “Get” request or it can be used in a publish scenario, where it pushes information to other applications based on a business event. Although BODs based on this verb may not cause updates to occur, at times the component receiving the “Show” may use the information it receives to update. In some embodiments, whether to cause an update is under the control of the receiving software component.

Response BOD 610, “ShowWorkforceEvent,” may be used to respond to a “Get Workforce Event” BOD requesting information on a particular workforce event. A workforce event could be, for example, compensation change, promotion or job change, organizational transfer, status change, and separation. BOD 610 includes application area 620 and data area 630. Data area 630 includes verb 640, in this example indicating the action is “Show,” and noun 650, “WorkforceEvent.” Noun 650 includes ID field 652 that contains a unique identifier for the workforce event, name field 654 that contains a common name for the workforce event, initiator component 656 that contains the name of the user (i.e., the manager or his designated proxy) who initiates and submits the event, initiated date field 658, subject component 660 that contains the employee that is the subject of the workforce event, reason component 662 that contains a code recognizable by the system to describe the action to be taken with the employee, effective date field 664, transaction component 666 that contains one or more transactions to update parts of an employee record, workflow component 668 that, if enabled, holds information specific to the workflow instance, subordinate event component 669 that, when the workforce event can trigger another workforce event, contains details of the subordinate events, comment field 670, alert flag component 672 that indicates the workforce event contains transaction data that violates a business rule and may require an extra level of approval, and user area component 674.

Business services are invoked in some embodiments with business object documents, expressed in XML, that specify a request for information or for the service to take some action. The document sent to a business service indicates the action to be executed, along with the related domain and ancillary data required to perform the action.

Business services 120 and their business functions may be implemented as Java classes, providing a method for each BOD type supported. In some embodiments, all business methods accept an XML document conforming to the BOD schema.

Generally, for each BOD request verb type there is a corresponding response verb type. Pairing these request-response verbs with a noun type defines a business service method. For example, the “lookup” and “get” request type verbs may be paired with the “show” response type verb. In embodiments using XML, for example, a lookupDependents business service method accepts an XML document conforming to the LookupDependents schema and responds with an XML document conforming to the ShowDependents schema.

The signature for this method in the Java business service may be in the form:
public Document lookupDependents(Document doc);

The “doc” parameter could contain an instance of the LookupDependents schema that may have the form:

<?xml version=“1.0” encoding=“UTF-8”?>
<LookupDependents xmlns=“http://www.workscape.com/oagis”
xmlns:oa=“http://www.openapplications.org/oagis” xmlns:hr=“http://ns.hr-xml.org”
xmlns:xsi=“http://www.w3.org/2001/XMLSchema-instance”
xsi:schemaLocation=“http://www.workscape.com/oagis ../BODs/LookupDependents.xsd”
revision=“1.0.0” environment=“Production”
lang=“en-US”>

<oa:ApplicationArea>

<oa:Sender>

<oa:LogicalId>SelfService</oa:LogicalId>
<oa:Component>Benefits</oa:Component>
<oa:Task>MaintainDependents</oa:Task>
<oa:ReferenceId>12-9-3</oa:ReferenceId>
<oa:Confirmation>0</oa:Confirmation>
<oa:AuthorizationId>james.bond</oa:AuthorizationId>

</oa:Sender>
<oa:CreationDateTime>2004-04-17T09:30:47-05:00</oa:CreationDateTime>
<oa:Signature qualifyingAgency=“”/>
<oa:BODId/>
<oa:UserArea/>

</oa:ApplicationArea>
<DataArea>

<Lookup confirm=“Always” show=“Always”>

<oa:ReturnCriteria expressionLanguage=“XPath”>

<oa:SelectExpression>Employee/Id</oa:SelectExpression>

</oa:ReturnCriteria>
<LookupCriteria/>

</Lookup>
<Dependents>

<Employee>

<Id>007</Id>

</Employee>

</Dependents>

</DataArea>

</LookupDependents>

The above example illustrates a request “looking up” the dependents for the employee with ID “007.” The response document may have the form:

<ShowDependents xmlns=“http://www.workscape.com/oagis”
xmlns:oa=“http://www.openapplications.org/oagis” xmlns:hr=“http://ns.hr-xml.org”
xmlns:xsi=“http://www.w3.org/2001/XMLSchema-instance”
xsi:schemaLocation=“http://www.workscape.com/oagis
C:\matador-plat\of_platform\sdk\resources\grammar\Workscape\BODs\
ShowDependents.xsd” revision=“0.0.0” environment=“Production” lang=“en-US”>

<oa:ApplicationArea>

<oa:Sender>

<oa:LogicalId>SelfService</oa:LogicalId>
<oa:Component>BenefitsService</oa:Component>
<oa:Task>LookupDependents</oa:Task>
<oa:ReferenceId>12-9-3</oa:ReferenceId>
<oa:Confirmation>0</oa:Confirmation>
<oa:AuthorizationId>BenefitsService.v1</oa:AuthorizationId>

</oa:Sender>
<oa:CreationDateTime>2004-04-17T09:31:47-05:00</oa:CreationDateTime>

</oa:ApplicationArea>
<DataArea>

<oa:Show confirm=“Always”/>
<Dependents>

<Employee>

<Id>007</Id>
<Ssn>123456789</Ssn>
<Name>

<hr:GivenName>James</hr:GivenName>
<hr:FamilyName primary=“undefined” prefix=“String”>Bond</hr:FamilyName>

</Name>

</Employee>
<Dependent>

<Id>99</Id>
<Ssn>987654321</Ssn>
<Name>

<hr:GivenName>Kristin</hr:GivenName>
<hr:FamilyName>Bond</hr:FamilyName>

</Name>

</Dependent>
<Dependent>

<Id>33</Id>
<Ssn>867530999</Ssn>
<Name>

<hr:GivenName>John</hr:GivenName>
<hr:FamilyName>Bond</hr:FamilyName>

</Name>

</Dependent>

</Dependents>

</DataArea>

</ShowDependents>

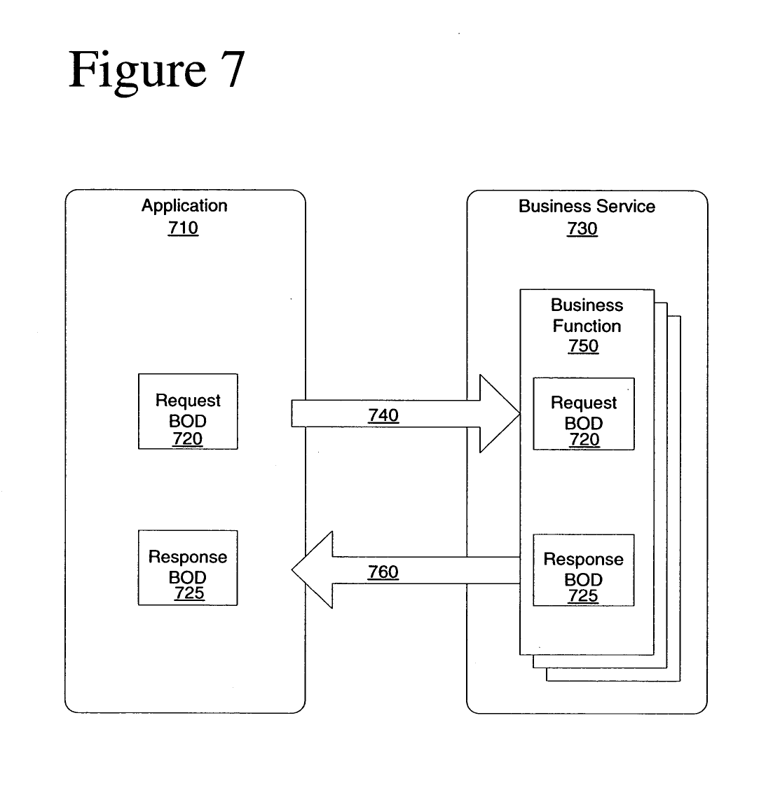

An example of the use of BODs to access a business function is shown in FIG. 7. Internal application 710 calls a business service using a function call, and provides the business function and a BOD as parameters. The function call may be in the form:
BusinessService.functionMethod (BOD);

In this example, “BusinessService” corresponds to the name of the business service and “function Method” corresponds to the name of the business function within the named business service. Applications may have graphical user interfaces, and applications are constructed to allow for the runtime or dynamic determination of the nouns and verbs used within a BOD for a call to a business service.

Application 710 passes request BOD 720 to business service 730 in step 740. Business function 750 uses the verb and noun from the BOD to perform the requested action, and then generates response BOD 725 by selecting a response verb and a noun. Business service 730 returns response BOD 725 to internal application 710 in step 760. Internal application 710 can display, forward, and/or otherwise process the returned data. Alternatively, or in addition, the application can make another function call to a business service, with the subsequent function call optionally using some or all of the returned data. For example, request BOD 720 may instruct business function 750 to look up dependents data for a particular employee, identified by social security number, name, or some other identification number. Response BOD 725 may provide the requested dependents information to the application, where it may be displayed.

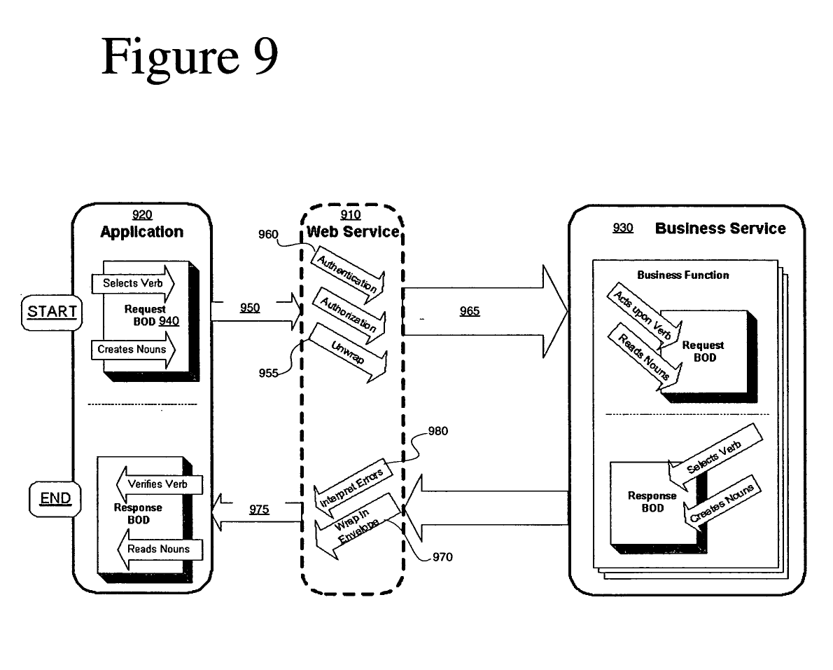

Referring to FIG. 9, web services 910 provide external applications 920 with access to the business services 930. Web services 910 expose the same set of document-based business service methods that are available to internal applications. This may cause a desire to authenticate and authorize requests from clients of this type. In some embodiments, business services 930 are not aware of the type of application making the request. External applications 920 wrap their BOD request 940 in an envelope (e.g., with Simple Object Access Protocol (SOAP), an industry standard for the communication of web service requests) including authentication information, and calls the corresponding web service in step 950. The web service removes the wrapper in step 955, authenticates the client in step 960 and passes the request BOD to the appropriate business service in step 965. The response BOD is wrapped in an envelope in step 970 and returned to the 3rd party application in step 975. Error handling with web services is shown at step 980. The SOAP wrapper itself may indicate failure, allowing the client to execute special error handling rather than unwrapping the BOD response document to learn of failure.

An exemplary internal application is “Organization Transfer,” when an employee is transferred to another manager, organization, and/or location. In some embodiments, upon execution, the Organization Transfer application generally proceeds through the following steps. The following description of steps for the Organization Transfer application is illustrative. Other sequences of steps and other specific technologies may be substituted as appropriate.

First, the application user selects an employee (or subject) and the event to apply to the subject (which may involve another application).

Next, the application user selects an event reason, which explains why the event is needed. To permit the user to select an event reason, the application retrieves the subject from the context of the session and retrieves event reasons. Then, business rules that relate to search constraints are retrieved and applied. The application forwards this information to a Java Server Page (JSP) for display, which permits the user to select a reason.

The selected event reason is saved in the session until the event is committed. Event reasons can be stacked, permitting multiple reasons to be entered. Each reason has a subsequent search screen, to find the new target manager, organization, and/or location. The user enters the relevant criteria in the search screen and submits them.

The application performs some input validation. If no errors are identified, the application creates a Business Object Document (BOD) object. The application (through an Action class) then invokes the Corporate Service business service, which looks up the application-specific Enterprise JavaBeans (EJB) Business Service Function and calls the specific business method, passing the BOD. The EJB Business Service Function breaks the BOD into a Noun and a Verb, invokes the EJB Data Access Component (DAC), and passes the Verb and Noun to a lookupList method, which parses the XML within the Verb and Noun, and forms a database query (e.g., a SQL query) from them. The DAC then executes the query. Alternatively, servlets or other technology could be used in place of the EJBs.

From the records returned from the query, the DAC builds Nouns and returns them to the Business Function. The Business Function creates a response BOD, adds the Nouns to it and returns to the Corporate Service, which then returns it to the application. The application pulls the list of Nouns out of the XML document and breaks the data into chunks to be displayed in the JSP. Control is forwarded to the JSP to display the results.

The user then selects the appropriate item from the search screen and then moves to an “Effective Date” screen, to specify when the event will become effective. The date is saved until the event is committed, and the application then displays a Confirmation screen. The confirmation screen displays the subject's state before the event and the state after the event is committed, at which point the user can confirm (submit) the event.

The application then builds a workforceEvent document containing the data and invokes the Managerial Service business service. The Managerial Service invokes the Manage Workforce Events business function. This business function inserts an event into an Event database table and invokes the Workflow Service (from the Platform Services). The Workflow Service creates a workflow process instance and returns a process instance ID and AcknowledgeVerb, stating that the event has completed successfully.

An Acknowledgement screen then is displayed to the user and the workforce event is complete.

In some embodiments, each business function is associated with a particular business service. An application may call multiple business services and/or multiple business functions within a particular business service.

Business functions may be added to a business service without changing the rest of the business functions grouped under that business service, by making the particular business function name known to the application. Calls to the pre-existing functions remain unchanged.

The code for a business function also may be changed without affecting other parts of the system. The call to the business function will remain the same, so the application is not affected.

At a lower level, if for example a particular noun is changed, then the noun is changed for all functions that use that noun because there is a common definition of that noun for all functions.

The present invention may be implemented in a variety of forms, using software and/or firmware, running on one or more processors for a computing system. The code can be provided in any machine-readable medium, including magnetic or optical disk, or in memory. In some embodiments, the system uses J2EE-based application servers, such as BEA WebLogic or IBM WebSphere application servers; a Crystal reporting server; a relational database (such as an Oracle database); and web servers (which may, for example, be based on open source or proprietary systems).

While there have been shown and described examples of the present invention, it will be readily apparent to those skilled in the art that various changes and modifications may be made without departing from the scope of the invention as defined by the following claims. Accordingly, the invention is limited only by the following claims and equivalents thereto.

What is claimed is:

1. A human resource application system comprising:
a human resource application including a graphical user interface;
a plurality of business services, each business service corresponding to a human resource process and including one or more business functions, the business functions including logic for implementing the human resource process;
a data repository; and
a data access component for mapping data between the business functions and the data repository,
wherein the human resource application accesses one or more of the plurality of business services and communicates with at least one of the business functions using one or more business object documents.

2. The system according to claim 1, further comprising a communication protocol and dispatch component for reformatting the business object documents as needed for communications between the human resource application and the at least one of the business functions.

3. The system according to claim 2, wherein the human resource application includes an external application that accesses one or more of the plurality of business services through the communication protocol and dispatch component.

4. The system according to claim 2, wherein the human resource application includes an internal application that communicates with the at least one of the business functions without the communication protocol and dispatch component.

5. A method for managing human resources comprising:
accepting a function request from a human resource application, the function request including a first document and identifying a business function selected from a plurality of business functions, the first document including a first verb that represents an action requested and a first noun that represents a business object on which the first verb is to act;
mapping a business object represented by the first noun into a data structure in a data repository; and
sending a response to the function request to the human resource application, the response including a second document, the second document including a second verb that represents an action requested and a second noun, the second noun containing a representation of data received from the data repository.

6. The method according to claim 5, wherein the first noun and the second noun are of a same type.

7. The method according to claim 5, wherein the first noun and the second noun are of different types.

8. The method according to claim 5, wherein the second noun is a list of nouns.

9. The method according to claim 5, wherein the function request is a request generated by an employee to access information concerning the employee in the data repository.

10. The method according to claim 9, wherein the human resource business function selected is a maintain employee function.

11. The method according to claim 5, wherein the function request is generated by a human resources manager to access information concerning an employee in the data repository.

12. The method according to claim 11, wherein the human resource business function selected is a manage workforce events function.

13. The method according to claim 5, wherein the function request is generated by a system user to log in to the system.

14. The method according to claim 13, wherein the human resource business function selected is a login request function.

15. The method according to claim 5, further comprising publishing data for the use of an external application.

16. A computer program product, residing on a computer-readable medium, for use in implementing human resource applications, the computer program product comprising instructions for causing a processor to:
receive a function request from an application, the function request identifying a human resource business service and a human resource business function and including a first object, the first object including a first verb that represents an action requested and a first noun that represents a business object on which the verb is to act;
send to a data repository a request for data based on the first verb and the first noun;
receive from the data repository data corresponding to the data request; and
respond to the first function request with a response, the response including a second object, the second object including a second verb that represents an action requested and a second noun, the second noun containing data received from the data repository.

17. A business service module for a computer system comprising:
a request component for accepting a function request from a human resource application, the function request including a first document and identifying a business function selected from a plurality of business functions, the first document including a first verb that represents an action requested and a first noun that represents a business object on which the first verb is to act;
a data access component for mapping a business object represented by the first noun into a data structure in a data repository; and
a response component for sending a response to the function request to the human resource application, the response including a second document, the second document including a second verb that represents an action requested and a second noun, the second noun containing a representation of data received from a data repository.

18. A method for managing human resources comprising:
sending a function request identifying a human resource business service and a human resource business function and including a first object, the first object including a first verb that represents an action requested and a noun that represents a business object on which the first verb is to act, wherein the business object corresponds to a data structure in a human resources data repository;
receiving a response to the function request, the response including a second object, the second object including a second verb that represents an action requested and the noun, the noun containing data received from the human resources data repository; and
processing the data received from the human resources data repository.

19. The method for managing human resources according to claim 18, wherein processing the data received from the human resources data repository includes displaying the data.

20. The method for managing human resources according to claim 18, wherein processing the data received from the human resources data repository includes using the data in a second function request.

21. The method for managing human resources according to claim 18, wherein the function request identifies the human resource business service by use of a name of the function request.
